(19) United States
(12) Patent Application Publication
(10) Pub. No.: US 2015/0378589 A1
(43) Pub. Date: Dec. 31, 2015

(54) UTILIZING KEY POINTS IN A PROGRESS BAR TO BROWSE THROUGH CONTENT

(71) Applicant: International Business Machines Corporation, Armonk, NY (US)

(72) Inventors: Jian Wen Chi, Shanghai (CN); Run Hua Chi, Shanghai (CN); Zhen Hong Ding, Shanghai (CN); Fang Liang Dong, Shanghai (CN); Chang Lei, Shanghai (CN); Zhao Yang, Shanghai (CN); Wei Jun Zheng, Shanghai (CN)

(21) Appl. No.: 14/745,651

(22) Filed: Jun. 22, 2015

(30) Foreign Application Priority Data
Jun. 27, 2014 (CN) 201410302867.2

(51) Int. Cl. G06F 3/0485; G06F 3/0488; G06F 3/0484

(52) U.S. Cl. CPC G06F 3/04855; G06F 3/04842; G06F 3/0488

(57) ABSTRACT

One aspect is a method for utilizing key points in a progress bar to browse through content. The method includes displaying one or more hill-shaped flags at each of one or more key points on the progress bar such that a hill top of each of the one or more hill-shaped flags corresponds to a respective key point of the one or more key points. The progress bar has a slider configured to slide along the progress bar. The method further includes sliding the slider through a first hill-shaped flag, of the one or more hill-shaped flags, on the progress bar automatically, responsive to browsing content. The method further includes decreasing, by a computer processor, a content browsing speed from a first speed to a second speed, responsive to the slider sliding through the first hill-shaped flag.

### TECHNICAL FIELD

Various embodiments of this disclosure relate to a field of computer user interface and, more specifically, to utilizing key points in a progress bar to browse through content.

### BACKGROUND

Facing massive data in the information age, it is important to quickly spot key information when browsing through content such as media content. However, key information is easy to neglect, especially on a small screen of a mobile device, during fast forward or backward operations of media, or when a user drags a slider in a progress bar for quick browsing with fingers. This is because it is very difficult to drag the slider to a precise point using fingers on the small screen of the mobile device.

Some methods exist for spotting key information. FIG. 2A illustrates an example of showing preview thumbnails at the bottom of a media player by hovering a mouse pointer over a progress bar. FIG. 2B illustrates an example of using discrete points to flag key points (see the ellipse in the lower right part of FIG. 2B). When the mouse pointer is moved to a certain discrete point in the progress bar shown in FIG. 2B, a single frame corresponding to the point is shown in a thumbnail (see the ellipse in the lower left part of FIG. 2B).

### SUMMARY

One embodiment is a method for utilizing key points in a progress bar to browse through content. The method includes displaying one or more hill-shaped flags at each of one or more key points on the progress bar such that a hill top of each of the one or more hill-shaped flags corresponds to a respective key point of the one or more key points. The progress bar has a slider configured to slide along the progress bar. The method further includes sliding the slider through a first hill-shaped flag, of the one or more hill-shaped flags, on the progress bar automatically, responsive to browsing content. The method further includes decreasing, by a computer processor, a content browsing speed from a first speed to a second speed, responsive to the slider sliding through the first hill-shaped flag.

Another embodiments is a system for utilizing key points in a progress bar to browse through content. The system includes a memory having computer readable instructions and one or more processors for executing the computer readable instructions. The computer readable instructions include displaying one or more hill-shaped flags at each of one or more key points on the progress bar such that a hill top of each of the one or more hill-shaped flags corresponds to a respective key point of the one or more key points. The progress bar has a slider configured to slide along the progress bar. The computer readable instructions further include sliding the slider through a first hill-shaped flag, of the one or more hill-shaped flags, on the progress bar automatically, responsive to browsing content. The computer readable instructions further include decreasing a content browsing speed from a first speed to a second speed, responsive to the slider sliding through the first hill-shaped flag.

Yet another embodiment is a computer program product for utilizing key points in a progress bar to browse through content. The computer program product includes a computer readable storage medium having program instructions embodied therewith. The program instructions are executable by a processor to cause the processor to perform a method. The method includes displaying one or more hill-shaped flags at each of one or more key points on the progress bar such that a hill top of each of the one or more hill-shaped flags corresponds to a respective key point of the one or more key points. The progress bar has a slider configured to slide along the progress bar. The method further includes sliding the slider through a first hill-shaped flag, of the one or more hill-shaped flags, on the progress bar automatically, responsive to browsing content. The method further includes decreasing a content browsing speed from a first speed to a second speed, responsive to the slider sliding through the first hill-shaped flag.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 shows a block diagram of an example computer system for implementing some embodiments of this disclosure;

FIG. 2A illustrates an example of showing preview thumbnails at the bottom of a media player by hovering a mouse pointer over a progress bar;

FIG. 2B illustrates an example of using discrete points to flag key points;

FIG. 3 is a diagram illustrating hill-shaped flags used to flag key points, according to some embodiments of this disclosure;

FIG. 4 is a diagram illustrating an application example of hill-shaped flags, according to some embodiments of this disclosure;

FIG. 5 is a flowchart illustrating a method for utilizing key points in a progress bar to browse through content, according to some embodiments of this disclosure;

FIG. 6 is a diagram illustrating an application example of different heights of hill tops of hill-shaped flags, according to some embodiments of this disclosure;

FIG. 7 illustrates an example of displaying a magnified view when playing to a hill-shaped flag with a flat top, according to some embodiments of this disclosure;

FIG. 8 is a flowchart illustrating a method for utilizing key points in a progress bar to browse through content, according to some embodiments of this disclosure;

FIG. 9 is a schematic diagram illustrating a process of creating a hill-shaped flag manually by a user, according to some embodiments of this disclosure;

FIG. 10 is a flowchart illustrating an example of a method of creating a hill-shaped flag, according to some embodiments of this disclosure;

FIG. 11 is a diagram illustrating automatically created hill-shaped flags, according to some embodiments of this disclosure;

FIG. 12 illustrates a result after performing merging on consecutive hill-shaped flags in FIG. 11, according to some embodiments of this disclosure;

FIG. 13 is a block diagram illustrating an apparatus for utilizing key points in a progress bar to browse through content, according to some embodiments of this disclosure; and

FIG. 14 is a block diagram illustrating an apparatus for utilizing key points in a progress bar to browse through content, according to some embodiments of this disclosure.

### DETAILED DESCRIPTION

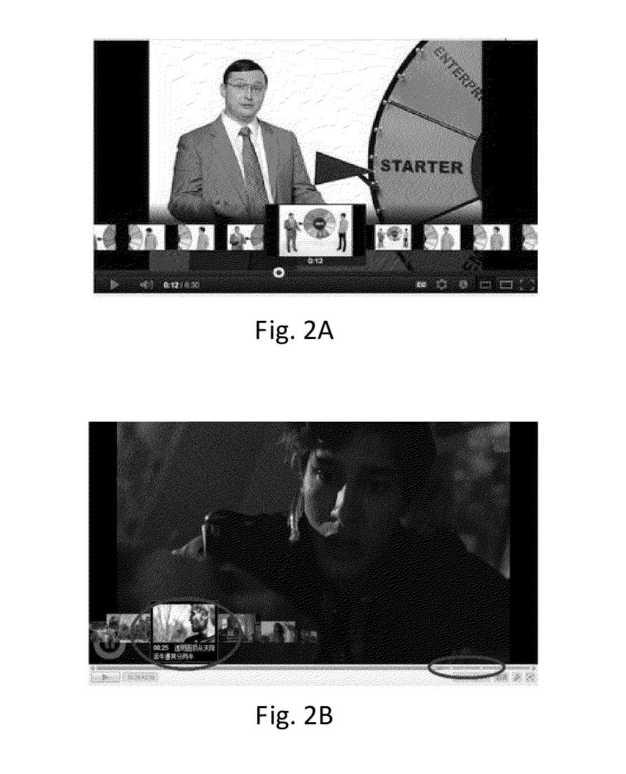

When reading an e-book or a document, browsing through a web page, or searching an email in an email box in a mobile device or a computer device, a user wants to be able to spot key information quickly. In the example of FIG. 2A, a user cannot know in which specific position of media content the key information is located. In the example shown in FIG. 2B, while there are key points indicating positions of key information, the media player depicted is designed for a computer with a large screen. When these small points are displayed densely on the small screen of a mobile device and click operations need to be performed with fingers, which have contact areas much larger than the mouse pointer, it is difficult to select a key point in the progress bar accurately. Furthermore, when there are a plurality of key points, the viewer does not know which key points are most important. In addition, key points shown in FIG. 2B are only discrete points, and no consecutive context around key points can be previewed. In terms of video, key information at a key point of the video can be generally better understood only after watching the consecutive context around the key point (i.e., through multiple frames).

Embodiments of this disclosure include a method and an apparatus for utilizing novel hill-shaped flags in a progress bar to avoid neglecting key information when fast browsing content. Some embodiments may be easily useable on small screens, such as those on mobile devices.

Some embodiments will be described in more detail with reference to the accompanying drawings, in which those embodiments are illustrated. However, this disclosure can be implemented in various manners, and thus should not be construed to be limited to the embodiments disclosed herein. On the contrary, those embodiments are provided for the thorough and complete understanding of the present disclosure.

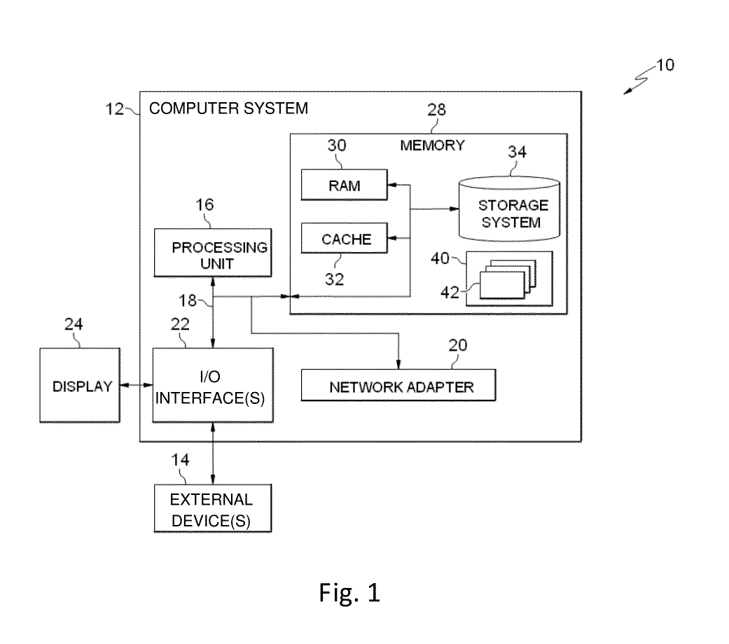

FIG. 1 shows a block diagram of an exemplary computer system 12, such as a server, which may be applicable to implement the embodiments of this disclosure. Computer system 12 shown in FIG. 1 is only illustrative and is not intended to suggest any limitation as to the scope of use or functionality of embodiments of this disclosure described herein.

As shown in FIG. 1, computer system 12 is shown in the form of a general-purpose computing device. The components of computer system 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable or non-removable, volatile or non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of this disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc.

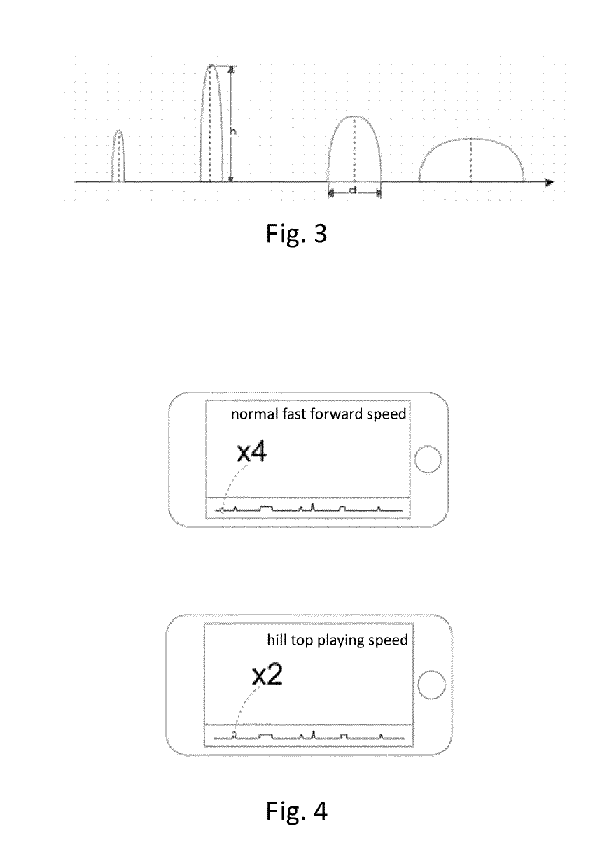

With reference now to FIG. 3, FIG. 3 is a diagram illustrating hill-shaped flags used to flag key points, according to some embodiments of this disclosure. As shown in FIG. 3, instead of using discrete points, according to some embodiments, hill-shaped flags are used to highlight key points and the context around them. In some embodiments, the hill-shaped flag has a shape similar to a “hill” in the real world. The hill-shaped flag includes an uphill portion from the hill foot to the hill top and a downhill portion from the hill top to the hill foot on the other side, wherein the hill top is located at the center of the hill-shaped flag and corresponds to the position of the key point, and the hill-shaped flag is symmetric with respect to its centerline (broken lines in FIG. 3). In some embodiments, however, the hill-shaped flag may have other shapes. For example, the hill top of the hill-shaped flag may be an arc-shaped top, a sharp top or a flat top. In addition, the uphill portion and the downhill portion of the hill-shaped flag may be straight lines instead of arc lines. In some embodiments, relative to the case in FIG. 3, the hill-shaped flag may be upside down, i.e., the hill top is directed downward. Those skilled in the art may understand that other shapes of the hill-shaped flag may be used, such as triangle, trapezoid, and various variants, as long as the hill-shaped flag has a hill top, an uphill portion and a downhill portion.

In addition, in some embodiments, the height h of the hill top of the hill-shaped flag denotes the importance of the key point corresponding to the hill-shaped flag. The higher the height h of the hill top is, the higher the importance may be. The width d of the hill-shaped flag may denote the number of adjacent points (context) on both sides of the key point corresponding to the hill-shaped flag.

When a user fast browses through the flag area, the hill-shaped flag enables the user to slow down the browsing speed smoothly and preview the key point and its context continuously, to avoid neglecting key information during fast browsing (e.g., in a multi-speed play mode or when dragging the slider to fast-forward manually). FIG. 4 is a diagram illustrating an application example of hill-shaped flags, according to some embodiments of this disclosure. In FIG. 4, the upper diagram illustrates an example of fast browsing media (such as video or audio) at a set fast-forward speed (i.e., ×4 in this case) in a hill-shaped flag free area, and the lower diagram illustrates an example of fast browsing media at a speed obtained by decreasing the original fast forward speed by a half (i.e., decreasing it to ×2) at the hill top of the hill-shaped flag.

In the real world, climbing up the hill will decrease the travelling speed while climbing down the hill will increase the travelling speed. This common knowledge makes the hill-shaped flag according to an embodiment of this disclosure very intuitive. Therefore, even a user who has never before seen or used the hill-shaped flag can immediately know its function at a glance.

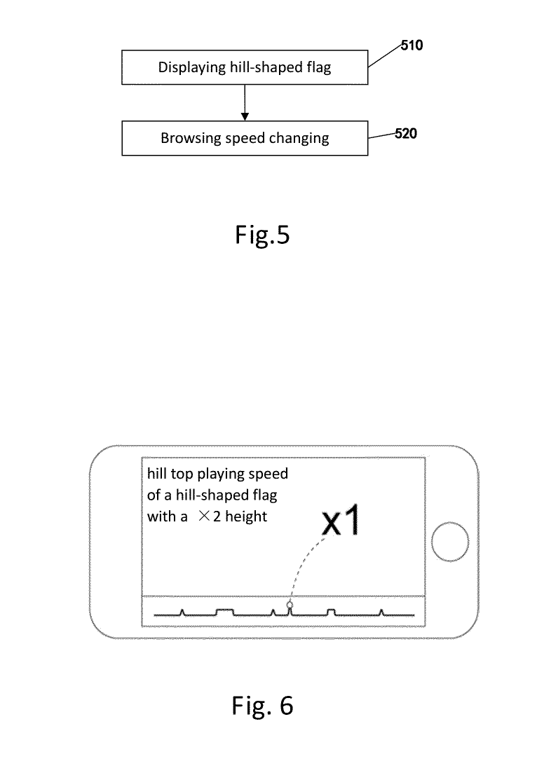

FIG. 5 is a flowchart 500 illustrating a method for utilizing key points in a progress bar to browse through content, according to some embodiments of this disclosure. The example in FIG. 5 illustrates automatic fast forward.

At block 510, hill-shaped flags are displayed at key points on said progress bar so that hill tops of the hill-shaped flags correspond to said key points, where the progress bar has a slider that may slide along the progress bar. Taking the case in FIG. 4 as an example, 6 hill-shaped flags are displayed on the progress bar. In some embodiments, in a case where a plurality of hill-shaped flags are arranged consecutively, the plurality of hill-shaped flags may be merged into one hill-shaped flag with a flat top. For example, the 2^{nd} and the 5^{th} hill-shaped flags in the progress bar in FIG. 4 are shown as hill-shaped flags that have flat tops and have resulted from merging a plurality of hill-shaped flags. By merging a plurality of hill-shaped flags arranged consecutively, the user interface may be more concise. At this time, the span of the merged hill-shaped flag may reflect the number of key points in that area.

To change browsing speed, at block 520, in response to browsing of content, the slider slides through a hill-shaped flag in the progress bar automatically so that, during the process of the slider sliding through the hill-shaped flag, the content browsing speed is decreased from a first speed to a second speed that is lower than the first speed.

In some embodiments, when the slider enters into the range of the hill-shaped flag, the content browsing speed is decreased from the first speed to the second speed that is lower than the first speed and remains at the second speed until the slider goes out of the range of the hill-shaped flag. After the slider goes out of the range of the hill-shaped flag, the content browsing speed returns to the first speed from the second speed.

In some embodiments, however, the content browsing speed being decreased from the first speed to the second speed that is lower than the first speed further includes: the content browsing speed being decreased gradually from the first speed to the second speed that is lower than the first speed during the process of sliding from the hill foot to the hill top of the hill-shaped flag, and the content browsing speed returning gradually to the first speed from the second speed during the process of sliding from the hill top to the hill foot on the other side of the hill-shaped flag.

In some embodiments of this disclosure, the progress bar is the progress bar of a media player, and respective points on the progress bar correspond to respective frames of media content played by the media player. Taking the case in FIG. 4 as an example, it is assumed that the user needs to fast browse media content, so he sets to perform fast-forward playing at a ×4 speed of normal playing speed (see the upper part of FIG. 4). Here, the fast-forward playing speed corresponds to the content browsing speed. When the slider slides to the hill foot of the first hill-shaped flag in FIG. 4, the fast-forward playing speed is still ×4 speed. When the slider begins to slide along the uphill portion from the hill foot to the hill top of the hill-shaped flag, the fast-forward playing speed is decreased gradually. That is, the fast-forward playing speed at each point when sliding uphill is variable and varies with the distance from the hill top (the closer to the hill top, the lower the fast forward playing speed). When the slider arrives at the hill top (i.e., the center) of the hill-shaped flag, the fast-forward playing speed is decreased to the lowest.

In some embodiments, the hill top playing speed Sₜ=Sₙ/p. Sₙ is the normal fast forward playing speed; p is a variable related to the height of the hill-shaped flag (i.e., the importance of the key point flagged by the hill-shaped flag); and the more important the key point is, the larger the value of p is. For example, provided that the p value of the first hill-shaped flag in FIG. 4 is 2 and Sₙ=4 (i.e., ×4 speed), the hill top playing speed Sₜ=Sₙ/p=4/2=2 (×2 speed). Still taking the case in FIG. 4 as an example, provided that the slider travels to the 4^{th} hill-shaped flag in FIG. 4 and the p value of the 4^{th} hill-shaped flag is 4, at this time, as shown in FIG. 6, the hill top playing speed Sₜ=Sₙ/p=4/4=1 (×1 speed). That is, when arriving at the key point with a higher level of importance flagged by the 4^{th} hill-shaped flag, the player decreases the fast forward playing speed to ×1 speed (i.e., the normal playing speed) automatically, so that the viewer may learn about content of the key point and its context in more detail and may easily distinguish different levels of importance of key information at different key points.

In some embodiments, however, when the slider begins to slide along the downhill portion from the hill top to the hill foot on the other side of the hill-shaped flag, the fast-forward playing speed is increased gradually from the lowest speed. That is, the fast forward playing speed at each point when sliding downhill is variable and varies with the distance from the hill top (i.e., the more distant from the hill top, the higher the fast forward playing speed). When the slider arrives at the hill foot on the other side of the hill-shaped flag, the fast-forward playing speed returns to the set fast forward playing speed. In the examples of FIGS. 4 and 6, when the slider slides to the hill foot on the other side of the hill-shaped flag, the fast forward playing speed returns to ×4 speed.

Hereinabove, an application example of the hill-shaped flag according to an embodiment of this disclosure is explained by taking the media player as an example. In some embodiments, however, the progress bar is a transverse or longitudinal scrollbar in a software window, respective points on the transverse scrollbar correspond to respective columns of content displayed in the window, and respective points on the longitudinal scrollbar correspond to respective rows of content displayed in the window. In such embodiments, hill-shaped flags may be displayed on the scrollbars of the software window, and the software may have an automatic browsing function. The software may be for example: a web browser that automatically scrolls and displays web pages, word processing software that automatically scrolls and displays documents, a reader that automatically scrolls and displays book pages or documents, an email program that automatically scrolls and displays a mail list, etc. For example, in the web browser, respective points on its longitudinal scrollbar correspond to respective rows of content in a web page, and respective points on its transverse scrollbar correspond to respective columns of content in the web page. By scrolling the scrollbars, content in the software window may be scrolled out of the window, and also, content that is not displayed in the software window may be scrolled into the window.

Those skilled in the art can understand that it is possible to control the speed of scroll-display according to hill-shaped flags displayed on the scrollbar in the same manner as in the embodiment of the above mentioned media player. Therefore, when the user fast browses content, such as web pages, documents, etc, other than media content, he can also notice key information and its context more easily and at the same time can distinguish different levels of importance of key information at different key points.

In some embodiments, a hill-shaped flag with width d corresponds to only one frame or one row of a document. That is, the hill-shaped flag corresponds to only the key point and does not include its context. In some other embodiments, a hill-shaped flag with the width d may correspond to a plurality of frames or a plurality of rows of a document. In some embodiments, a hill-shaped flag with the width d may correspond to media content of a unit time, e.g., correspond to video or audio of time duration of 1 second.

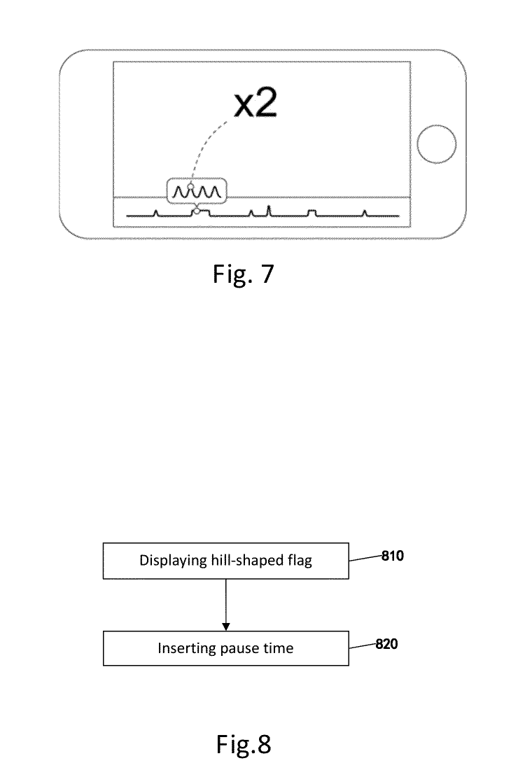

In some embodiments of this disclosure, when the slider travels to a hill-shaped flag with a flat top (e.g., the second flag in FIG. 4), a magnified view may be displayed near the hill-shaped flag. The magnified view specifically shows respective constituent hill-shaped flags that constitute the hill-shaped flag and the sliding process of the slider on these constituent hill-shaped flags, as shown in FIG. 7. In addition, in FIG. 7, provided that the p value of the second hill-shaped flag is 2 and Sₙ=4 (×4 speed), the hill top playing speed is Sₜ=Sₙ/p=4/2=2 (×2 speed). In some embodiments, the height of the hill top of the flat-top hill-shaped flag may be the average of heights of hill tops of respective constituent hill-shaped flags that constitute the hill-shaped flag. However, the height may be calculated by other methods.

FIG. 8 is a flowchart 800 illustrating a method for utilizing key points in a progress bar to browse through content, according to some embodiments of this disclosure. The embodiment in FIG. 8 illustrates an example of manual fast forward.

In block 810, hill-shaped flags are displayed at key points on a progress bar of a media player so that hill tops of the hill-shaped flags correspond to said key points, where the progress bar has a slider that may slide along the progress bar. Technical features described in previous embodiments (e.g., height, width of the hill-shaped flag, and the hill-shaped flag with a flat top, etc.) may be combined with these embodiments.

In block 820, in response to a user dragging the slider through a hill-shaped flag manually to fast browse media content, a short period of pause time is inserted into media content corresponding to the hill-shaped flag to produce a resistance sensation for said dragging.

In some embodiments, the short period of pause time may be inserted between arbitrary positions (e.g., arbitrary frames) of media content corresponding to the hill-shaped flag.

In some embodiments, inserting a short period of pause time into media content corresponding to the hill-shaped flag includes inserting a short period of pause time between respective frames of media content corresponding to the hill-shaped flag. Assuming that the user desires to fast browse a video clip, the user may utilize an indicator such as a finger, a stylus pen, a mouse, etc. to drag the slider in the progress bar. The movement of the slider corresponds to the movement of the indicator, and playing of the video corresponds to the movement of the slider. When the slider moves to a hill-shaped flag, similar to the case of climbing up a hill in the real world, the slider may need to slide a longer distance (in comparison with a hill-shaped flag free area), and because a short period of pause time (e.g., a millisecond-level period of pause time) is inserted between respective frames of a video clip corresponding to the hill-shaped flag, the user will have a resistance sensation, i.e., an unsmooth sliding sensation, so that the user will recognize that, at this time, there is key information in the video and will not neglect the key information.

In some embodiments, the durations of the inserted periods of pause time are not equal, and the closer to the hill top, the longer the inserted period of pause time is. In this case, the more the slider approaches the hill top, the stronger the resistance sensation is and the lower the playing speed of video is, so that the user can find key information more easily. In addition, embodiments of this disclosure are especially useful for the blind. When the blind drag the slider in the progress bar of the media player to fast browse audio, since the playing speed of audio is decreased gradually at the hill-shaped flag and resistance is felt, the blind can also recognize that there is key information here.

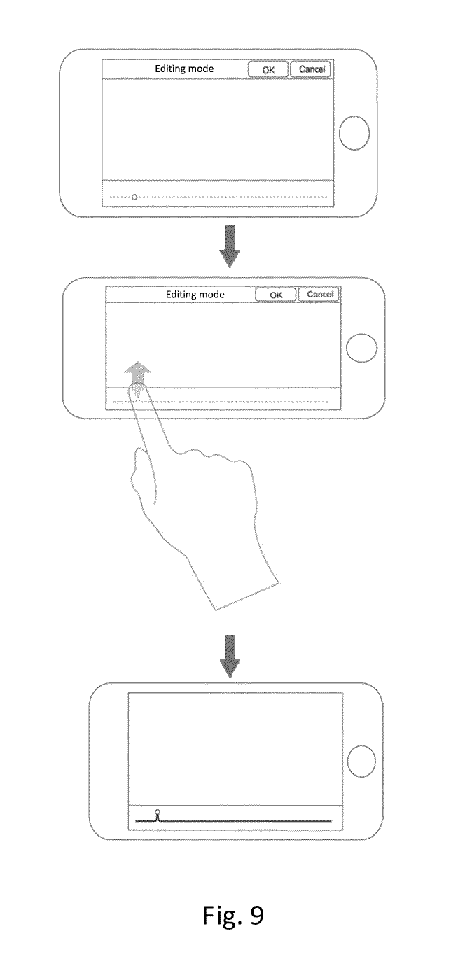

Hereinafter, how the hill-shaped flag according to some embodiments is created is explained in detail. In some embodiments, the hill-shaped flag may be created by the user manually. The manual creating includes the following, for example: the user uses an indicator to select one point in the progress bar as the key point; and the user uses the indicator to drag the key point on the progress bar in a direction perpendicular to the progress bar so as to form a hill-shaped flag, wherein the height of the hill top of the hill-shaped flag corresponds to the amplitude of the user dragging. Here, it may be necessary to perform manual creating of the hill-shaped flag in an editing mode different from the playing mode. FIG. 9 is a schematic diagram illustrating a process of creating a hill-shaped flag manually by a user. In the diagram in the upper part of FIG. 9, the user enters the editing mode by touching a certain button of the media player, and moves the slider in the progress bar to a point that is considered by the user to contain important information. In the diagram in the middle part of FIG. 9, the user uses a finger to touch the slider and drag the slider upward, and then the finger leaves the screen, so that a hill-shaped flag appears in the progress bar. The height of the hill top of the hill-shaped flag corresponds to the position where the user's finger leaves the screen. In the diagram in the lower part of FIG. 9, the user clicks the OK button to exit the editing mode so that the hill-shaped flag is created manually. With this embodiment, the user is not only the user of key points (hill-shaped flags), but also may customize key points themselves.

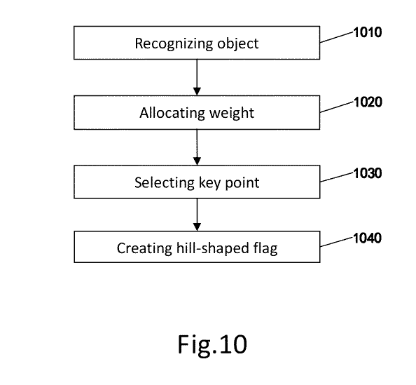

In some embodiments, the hill-shaped flag may be created automatically by a content provider or the user's computing apparatus. FIG. 10 is a flowchart illustrating an example of a method of creating a hill-shaped flag according to some embodiments. The flowchart in FIG. 10 includes the following: creating objects (block 1010), allocating weights (block 1020), selecting key points (block 1030), and creating hill-shaped flags (block 1040).

In the block 1010, recognition of at least one of a plurality of objects of a unit length media is performed, and the appearance frequencies of the at least one of the plurality of objects in the whole unit length media are checked. For example, the plurality of objects may include an object in an image (such as a face), an object in audio (such as a voice key word), an object in a caption (such as a text key word), etc. In addition, for example, the unit length media may be media with the length of 1 second, 10 seconds, 10 frames, 50 frames, etc.

Hereinafter, the method in FIG. 10 is explained through an example video clip. Assume that the length of the video is 10 seconds, the unit length media is a video clip with the length of 1 second, and the video contains an image with 15 frames for example. In this example the plurality of objects in the video include faces and voice key words. The example is merely exemplary, and in some embodiments, one or more types of object recognition may be used. Object recognition techniques other than face recognition and voice recognition may be used. In face recognition, a face may be recognized through a face recognition algorithm. In this example, through face recognition, it is found out that a character X appears in video clips 1, 2, 5, 6, 8 for 5 times, a character Y appears in video clips 4, 6, 8 for 3 times, and a character Z appears in only video clip 10 for a total of 1 time. In voice recognition, a key word may be recognized through a voice recognition algorithm. In this example, through voice recognition, it is found out that a key word China appears in video clips 1, 6, 8 for 3 times, a key word Japan appears in video clips 2, 6 for 2 times, and a key word Africa appears in only video clip 10 for 1 time.

In the block 1020, based on the appearance frequencies of the at least one of the plurality of objects and the object weights of the objects, the media weight is allocated to each unit length media. In face recognition, faces may be sorted in a descending order of the appearance frequency, and only a predetermined number of faces at the front are selected. For example, in the above example, only characters X and Y who appear 5 times and 3 times respectively are selected, and the character Z who appears only once is ignored. Here, for simplification of explanation, the appearance frequency of the character is considered to be the level of importance of the character, i.e., the higher the appearance frequency, the higher the level of importance of the character. For convenience of explanation, for a unit length media, the level of importance of the character object is equal to the sum of the levels of importance of respective characters (non-ignored) appearing in the unit length media.

In addition, in voice recognition, key words may be sorted in a descending order of the appearance frequency, and only a predetermined number of key words at the front are selected. For example, in the above example, only key words China and Japan which appear 3 times and 2 times respectively are selected; the key word Africa, which appears only once, is ignored. Here, for simplification of explanation, the appearance frequency of the key word is considered to be the level of importance of the key word. That is, the higher the appearance frequency is, the higher the level of importance of the key word is. Here, for convenience of explanation, for a unit length media, the level of importance of the voice key word object is equal to the sum of the levels of importance of respective key words (non-ignored) appearing in the unit length media.

In some embodiments, assume that a medium weight Wᵢ=Aᵢ×a+Bᵢ×b, for i=1, . . . , 10, is allocated to each unit length media (e.g., a video clip of 1 second in the above example), where Aᵢ is the level of importance of an object A appearing in a video clip i, Bᵢ is the level of importance of an object B appearing in a video clip i, a is the object weight of the object A, and b is the object weight of the object B. Here, only an example with two objects is illustrated. Of course, in some embodiments, more objects may be considered.

In some embodiments of this disclosure, the appearance frequencies of the at least one of the plurality of objects and the object weights of the objects can be changed manually by the user. In the above example, a user interface may be provided to the user to change the appearance frequencies of the objects and/or the object weights of the objects manually, thereby providing higher flexibility and accuracy.

Here, for convenience of explanation, assuming that the object A corresponds to the face and the object B corresponds to the voice key word, and both the object weight a of the object A and the object weight b of the object B are 1, in the above example, the media weight may be allocated to each video clip of 1 second with reference to the following table.

| Video clip | 1 | 2 | 3 | 4 | 5 | 6 | 7 | 8 | 9 | 10 |
|---|---|---|---|---|---|---|---|---|---|---|
| Character (object | X | X | | Y | X | X, Y | | X, Y | | Z |
| A) | | | | | | | | | | |
| Character | 5 | 5 | 0 | 3 | 5 | 5 + 3 | 0 | 5 + 3 | 0 | 0(ignored) |
| importance level | | | | | | | | | | |
| Key word (object | China | Japan | | | | China | | China | | Africa |
| B) | | | | | | Japan | | | | |
| Key word | 3 | 2 | 0 | 0 | 0 | 3 + 2 | 0 | 3 | 0 | 0(ignored) |
| importance level | | | | | | | | | | |
| Media weight | 8 | 7 | 0 | 3 | 5 | 13 | 0 | 11 | 0 | 0 |

In the block 1030, a frame at the center of a unit length media with a non-zero media weight is selected as the key point. Taking the video of the above example, with reference to the above table, frames at the centers of video clips 1, 2, 4, 5, 6, 8 are selected as key points.

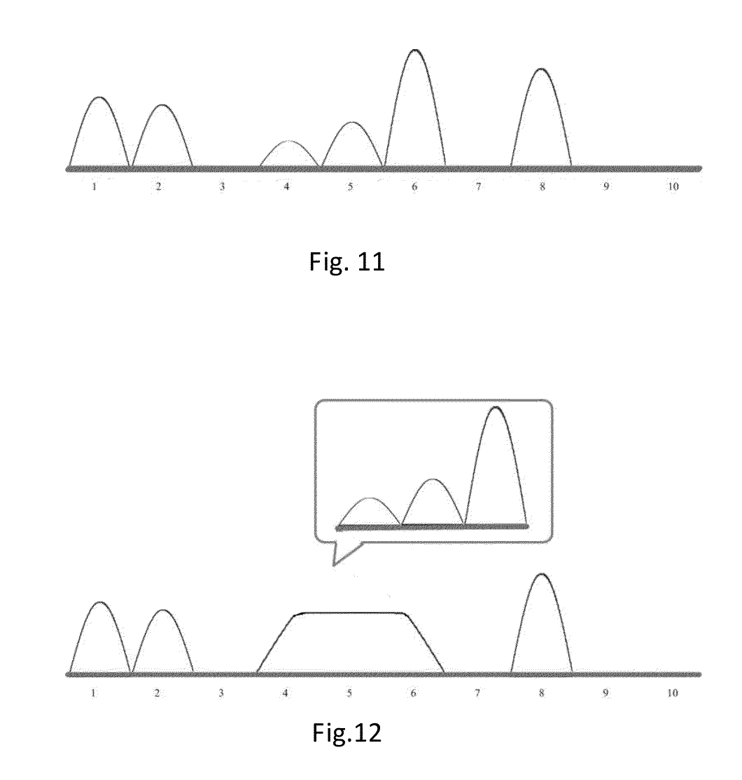

In the block 1040, at the selected key point, the hill-shaped flag is created so that the height of the hill top of the hill-shaped flag is in proportion to the allocated media weight. Taking the example video, a plurality of hill-shaped flags may be created as shown in FIG. 11, wherein the widths of these hill-shaped flags correspond to the width of the video clip of 1 second and the heights of these hill-shaped flags are in proportion to the media weights of the last row of the above-mentioned table.

In some embodiments, as for a plurality of consecutive hill-shaped flags, they may be merged into one hill-shaped flag with a flat top. In the example of FIG. 11, for example, said merging is performed on three or above consecutive hill-shaped flags and the hill-shaped flag as shown in FIG. 12 may be obtained. In a simple example, the height of the hill top of the merged flat-top hill-shaped flag may be the average of heights of hill tops of all hill-shaped flags in that area.

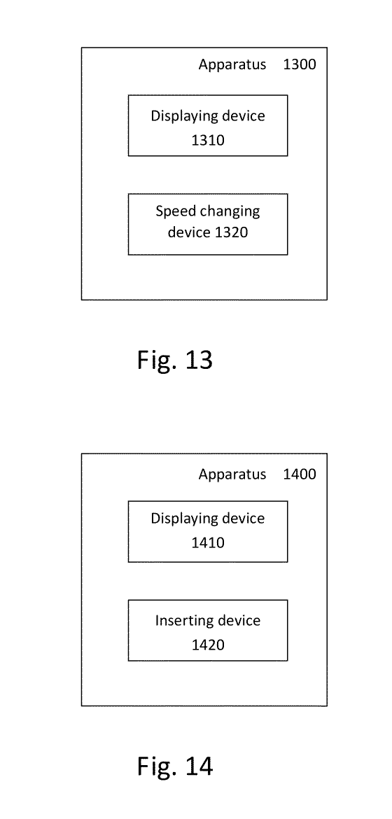

FIG. 13 is a block diagram illustrating an apparatus 1300 for utilizing key points in a progress bar to browse through content, according to some embodiments of this disclosure. The apparatus 1300 in FIG. 13 includes a displaying device 1310 and a speed changing device 1320. The displaying device 1310 is configured to display hill-shaped flags at key points on said progress bar, so that hill tops of the hill-shaped flags correspond to said key points, wherein the progress bar has a slider that may slide along the progress bar. The speed changing device 1320 is configured to slide, in response to browsing of content, the slider through a hill-shaped flag in the progress bar automatically so that, during the process of said slider sliding through said the hill-shaped flag, the content browsing speed is decreased from a first speed to a second speed that is lower than the first speed.

FIG. 14 is a block diagram illustrating an apparatus 1400 for utilizing key points in a progress bar to browse through content, according to some embodiments of this disclosure. The apparatus 1400 in FIG. 14 includes a displaying device 1410 and an inserting device 1420. The displaying device 1410 is configured to display hill-shaped flags at key points on a progress bar of a media player, so that hill tops of the hill-shaped flags correspond to said key points, wherein the progress bar has a slider that may slide along the progress bar. The inserting device 1420 is configured to insert, in response to a user dragging said slider through a hill-shaped flag manually to fast browse media content, a short period of pause time into media content corresponding to the hill-shaped flag to produce a resistance sensation for said dragging.

It is noted that though embodiments of this disclosure are especially suitable for use in a mobile terminal with a small screen, some embodiments may apply to a tablet computer, a laptop computer, a desktop computer etc, with a large screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for utilizing key points in a progress bar to browse through content, the method comprising:
displaying one or more hill-shaped flags at each of one or more key points on the progress bar such that a hill top of each of the one or more hill-shaped flags corresponds to a respective key point of the one or more key points, the progress bar having a slider configured to slide along the progress bar;
sliding the slider through a first hill-shaped flag, of the one or more hill-shaped flags, on the progress bar automatically, responsive to browsing content; and
decreasing, by a computer processor, a content browsing speed from a first speed to a second speed, responsive to the slider sliding through the first hill-shaped flag.

2. The method according to claim 1, wherein decreasing the content browsing speed from the first speed to the second speed comprises:
decreasing the content browsing speed gradually from the first speed to the second speed while sliding from a hill foot to the hill top of the first hill-shaped flag; and
returning the content browsing speed gradually to the first speed from the second speed while sliding from the hill top to the hill foot.

3. The method according to claim 1, wherein the progress bar is a progress bar of a media player, and respective points on the progress bar correspond to respective frames of media content played by the media player.

4. The method according to claim 1, wherein the progress bar is a transverse scrollbar in a software window, and respective points on the transverse scrollbar correspond to respective columns of content displayed in the window.

5. The method according to claim 1, further comprising:
in response to a user dragging the slider through the first hill-shaped flag manually, inserting a pause time into media content corresponding to the first hill-shaped flag to produce a resistance sensation for the dragging.

6. The method according to claim 1, wherein the height of the hill top of the first hill-shaped flag denotes the importance of the key point corresponding to the first hill-shaped flag, and the width of the first hill-shaped flag denotes a number of adjacent points on both sides of the key point corresponding to the first hill-shaped flag.

7. The method according to claim 1, further comprising automatically generating the first hill-shaped flag, wherein the generating comprises:
performing recognition of at least one of a plurality of objects in a plurality of unit length media, and checking the appearance frequencies of the at least one of the plurality of objects in the plurality of unit length media;
based on the appearance frequencies of the at least one of the plurality of objects and object weights of the plurality of objects, allocating a media weight to each of the plurality of unit length media;
selecting a frame at the center of a first unit length media with a non-zero media weight; and
at the first unit length media, creating the hill-shaped flag so that the height of the hill top of the hill-shaped flag is in proportion to the allocated media weight.

8. The method according to claim 1, further comprising merging two or more consecutive hill-shaped flags, of the one or more hill-shaped flags, into one hill-shaped flag with a flat top.

9. A system for utilizing key points in a progress bar to browse through content, the system comprising:
a memory having computer readable instructions; and
one or more processors for executing the computer readable instructions, the computer readable instructions comprising:
displaying one or more hill-shaped flags at each of one or more key points on the progress bar such that a hill top of each of the one or more hill-shaped flags corresponds to a respective key point of the one or more key points, the progress bar having a slider configured to slide along the progress bar;
sliding the slider through a first hill-shaped flag, of the one or more hill-shaped flags, on the progress bar automatically, responsive to browsing content; and
decreasing a content browsing speed from a first speed to a second speed, responsive to the slider sliding through the first hill-shaped flag.

10. The system according to claim 9, wherein decreasing the content browsing speed from the first speed to the second speed comprises:
decreasing the content browsing speed gradually from the first speed to the second speed while sliding from a hill foot to the hill top of the first hill-shaped flag; and
returning the content browsing speed gradually to the first speed from the second speed while sliding from the hill top to the hill foot.

11. The system according to claim 9, the computer readable instructions further comprising:
in response to a user dragging the slider through the first hill-shaped flag manually, inserting a pause time into media content corresponding to the first hill-shaped flag to produce a resistance sensation for the dragging.

12. The system according to claim 9, the computer readable instructions further comprising automatically generating the first hill-shaped flag, wherein the generating comprises:
performing recognition of at least one of a plurality of objects in a plurality of unit length media, and checking the appearance frequencies of the at least one of the plurality of objects in the plurality of unit length media;
based on the appearance frequencies of the at least one of the plurality of objects and object weights of the plurality of objects, allocating a media weight to each of the plurality of unit length media;
selecting a frame at the center of a first unit length media with a non-zero media weight; and
at the first unit length media, creating the hill-shaped flag so that the height of the hill top of the hill-shaped flag is in proportion to the allocated media weight.

13. A computer program product for utilizing key points in a progress bar to browse through content, the computer program product comprising a computer readable storage medium having program instructions embodied therewith, the program instructions executable by a processor to cause the processor to perform a method comprising:
displaying one or more hill-shaped flags at each of one or more key points on the progress bar such that a hill top of each of the one or more hill-shaped flags corresponds to a respective key point of the one or more key points, the progress bar having a slider configured to slide along the progress bar;
sliding the slider through a first hill-shaped flag, of the one or more hill-shaped flags, on the progress bar automatically, responsive to browsing content; and
decreasing a content browsing speed from a first speed to a second speed, responsive to the slider sliding through the first hill-shaped flag.

14. The computer program product according to claim 13, wherein decreasing the content browsing speed from the first speed to the second speed comprises:
decreasing the content browsing speed gradually from the first speed to the second speed while sliding from a hill foot to the hill top of the first hill-shaped flag; and
returning the content browsing speed gradually to the first speed from the second speed while sliding from the hill top to the hill foot.

15. The computer program product according to claim 13, wherein the progress bar is a progress bar of a media player, and respective points on the progress bar correspond to respective frames of media content played by the media player.

16. The computer program product according to claim 13, wherein the progress bar is a transverse scrollbar in a software window, and respective points on the transverse scrollbar correspond to respective columns of content displayed in the window.

17. The computer program product according to claim 13, further comprising:
in response to a user dragging the slider through the first hill-shaped flag manually, inserting a pause time into media content corresponding to the first hill-shaped flag to produce a resistance sensation for the dragging.

18. The computer program product according to claim 13, wherein the height of the hill top of the first hill-shaped flag denotes the importance of the key point corresponding to the first hill-shaped flag, and the width of the first hill-shaped flag denotes a number of adjacent points on both sides of the key point corresponding to the first hill-shaped flag.

19. The computer program product according to claim 13, the method further comprising automatically generating the first hill-shaped flag, wherein the generating comprises:
performing recognition of at least one of a plurality of objects in a plurality of unit length media, and checking the appearance frequencies of the at least one of the plurality of objects in the plurality of unit length media;
based on the appearance frequencies of the at least one of the plurality of objects and object weights of the plurality of objects, allocating a media weight to each of the plurality of unit length media;
selecting a frame at the center of a first unit length media with a non-zero media weight; and
at the first unit length media, creating the hill-shaped flag so that the height of the hill top of the hill-shaped flag is in proportion to the allocated media weight.

20. The computer program product according to claim 13, the method further comprising merging two or more consecutive hill-shaped flags, of the one or more hill-shaped flags, into one hill-shaped flag with a flat top.
